(19) United States
(12) Patent Application Publication
(10) Pub. No.: US 2008/0318832 A1
(43) Pub. Date: Dec. 25, 2008

(54) Liquid detergent compositions with low polydispersity polyacrylic acid based polymers

(76) Inventors: Robb Richard Gardner, Cincinnati, OH (US); Jeff Scott Dupont, Cincinnati, OH (US); Kenneth Nathan Price, Cincinnati, OH (US)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 11/820,371

(22) Filed: Jun. 19, 2007

(51) Int. Cl. C11D 17/08

(52) U.S. Cl. 510/434

(57) ABSTRACT

Liquid detergent compositions comprising a polymer comprising polyacrylic acid monomers having a low number average molecular weight, ranging from about 1000 to about 10,000 amu, and a very low polydispersity, less than about 5, wherein the liquid detergent comprises less than about 50% of any non-aminofunctional solvent. The invention is also directed to liquid detergents compositions comprising beneficial mixtures of the low molecular weight, very low polydispersity polyacrylic acid based polymers with specific polymers.

### FIELD OF THE INVENTION

The present invention is directed to liquid detergent compositions, and more particularly, to liquid laundry detergent compositions or liquid dish or surface cleaning detergents, comprising a polymer or copolymer comprising polyacrylic acid monomers and having a low polydispersity. These liquid detergents exhibit improved ability to formulate at lower solvent vehicle levels and improved performance of polymeric detergent additives.

### BACKGROUND OF THE INVENTION

Fluid laundry products, such as liquids, gels, pastes and the like are preferred by many consumers over solid detergents. Many of these consumers also have a desire to conserve resources and eliminate what they perceive as waste or unnecessary product, without a noticeable reduction in performance of the product. Consequently, there is renewed interest in concentrated or so called compact products. However, typical liquid detergent products cannot be easily formulated at lower levels of water or other solvents due to the need to keep detergent surfactants and polymeric additives which may become at least partially insoluble at higher concentrations.

Typical builders, such as citrates and fatty acids, and polymer additives, such as polyacrylates, and higher molecular weight/high charge density molecules, have shown a tendency to precipitate out of solution at lower solvent levels, thereby creating more instability in finished products. This instability may decrease the performance of the desired detergent products. Consequently, the need remains for a concentrated liquid detergent that is comparable to performance to existing noncompact detergents. Ideally any such comparable detergents will be presented in a fashion that is easy to use and which is aesthetically appealing to consumers.

Polyacrylic acid based polymers are known as builders or thickeners for detergent products. See U.S. Pat. No. 6,794,473 B2 issued to Yamaguchi et al. on Sep. 21, 2004. However, it has been found that polymers comprising acrylic acid monomers having low molecular weight and very low polydispersity create a concentrated, clear isotropic liquid detergents with sufficient physical stability and strong detergent performance.

Separately, it has been found that polymers comprising acrylic acid monomers having such a low molecular weight and very low polydispersity also enhances the stability and performance of previously used polymer additives, such as water-soluble or dispersible, modified polyamines and/or zwitterionic polyamines.

### SUMMARY OF THE INVENTION

Accordingly, it is an object of the present invention to provide improved liquid detergent compositions. Generally, the invention is directed to liquid detergent compositions comprising a polymer comprising polyacrylic acid monomers having a low number average molecular weight, ranging from about 1000 to about 10,000 amu, and a very low polydispersity, less than about 5, wherein the liquid detergent comprises less than about 50% of any non-aminofunctional solvent.

The invention is also directed to liquid detergents compositions comprising beneficial mixtures of the low molecular weight, very low polydispersity polyacrylic acid based polymers with specific polymers.

### DETAILED DESCRIPTION OF THE INVENTION

The liquid detergent compositions of the present invention comprise acrylic acid based polymers. By “acrylic acid based polymer” it is meant herein, a compound comprising repeating units called monomer units, wherein a fraction of the monomer units consist of acrylic acid or a salt of acrylic acid. In selected embodiments of the present invention, the polymer may be a homopolymer of acrylic acid where substantially 100% of the monomers are acrylic acid. In other embodiments of the invention the polymer may be a copolymer comprising some acrylic acid monomers and some other monomers.

The size of the polymers of the present invention may be measured by standard measurements of the average molecular weight. The molecular weight may be a number average molecular weight, Mn, or a weight average molecular weight, Mw. The polymers of the present invention may have a number average molecular weight ranging from about 1000 amu to about 10,000 amu. The distribution of the molecular weight of specific compounds of the polymer may be reflected in the ratio of the weight average molecular weight over the number average molecular weight (Mw/Mn). This ratio is also called the polydispersity of the polymer. The polymers of the present invention may have a polydispersity of less than about 5.0.

As discussed above, an embodiment of the polymer of the present invention may be a homopolymer of polyacrylic acid. The embodiment may have a number average molecular weight of from about 1000 to about 4000 and a polydispersity less than about 5, with certain embodiments having a number average molecular weight ranging from about 1100 to about 3000 and a polydispersity less than about 3.5.

The acrylic acid based polymer of the present invention may also be a copolymer comprising monomers of acrylic acid and 10% or less, based on the total weight of the polymer of a hydrophilic comonomer. Hydrophilic comonomers are monomers that when added to the acrylic acid polymer makes the copolymer less soluble in the liquid detergent composition. Typical hydrophilic monomers include polyethyleneglycol-acrylates, dicarboxylates, sulfonated monomers and mixtures thereof. Certain embodiments of polymers having hydrophilic comonomers may have a number average molecular weight of from about 1000 to about 4000 and a polydispersity less than about 5, with certain embodiments having a number average molecular weight ranging from about 1100 to about 3000 and a polydispersity less than about 3.5.

Other embodiments of the acrylic acid based polymer of the present invention may be a copolymer comprising monomers of acrylic acid and 20% or less, based on the total weight of the polymer of a hydrophobic comonomer. Hydrophobic comonomers are monomers that when added to the acrylic acid polymer makes the copolymer more soluble in the liquid detergent composition. Typical hydrophobic monomers include alkyl, aryl, silicone, propoxylated or butoxylated monomers and mixtures thereof. Certain embodiments of polymers having hydrophobic comonomers may have a number average molecular weight of from about 1000 to about 10000 and a polydispersity less than about 5, with certain embodiments having a number average molecular weight ranging from about 1100 to about 3000 and a polydispersity less than about 5.0.

The liquid detergent compositions of the present invention may be any liquid detergent including, but not limited to, liquid laundry detergents and liquid dish and surface cleaning compositions.

### Liquid Laundry Detergent Compositions

In one specific embodiment, the compositions are laundry detergent composition and are liquid in form and comprise heavy duty liquid compositions. The compositions of the present invention comprise surfactants, along with other typical detergent ingredients, and a polymer comprising polyacrylic acid monomers having a low number average molecular weight and very low polydispersity.

The laundry detergent composition comprises a surfactant in an amount sufficient to provide desired cleaning properties. In one embodiment, the laundry detergent composition comprises, by weight, from about 5% to about 90% of the surfactant, and more specifically from about 5% to about 70% of the surfactant, and even more specifically from about 5% to about 40%. The surfactant may comprise anionic, nonionic, cationic, zwitterionic and/or amphoteric surfactants. In a more specific embodiment, the detergent composition comprises anionic surfactant, nonionic surfactant, or mixtures thereof.

Suitable anionic surfactants useful herein can comprise any of the conventional anionic surfactant types typically used in liquid detergent products. These include the alkyl benzene sulfonic acids and their salts as well as alkoxylated or non-alkoxylated alkyl sulfate materials.

Exemplary anionic surfactants are the alkali metal salts of C₁₀₋₁₆ alkyl benzene sulfonic acids, preferably C₁₁₋₁₄ alkyl benzene sulfonic acids. Preferably the alkyl group is linear and such linear alkyl benzene sulfonates are known as “LAS”. Alkyl benzene sulfonates, and particularly LAS, are well known in the art. Such surfactants and their preparation are described for example in U.S. Pat. Nos. 2,220,099 and 2,477,383. Especially preferred are the sodium and potassium linear straight chain alkylbenzene sulfonates in which the average number of carbon atoms in the alkyl group is from about 11 to 14. Sodium C₁₁-C₁₄, e.g., C₁₂, LAS is a specific example of such surfactants.

Another exemplary type of anionic surfactant comprises ethoxylated alkyl sulfate surfactants. Such materials, also known as alkyl ether sulfates or alkyl polyethoxylate sulfates, are those which correspond to the formula: R′—O—(C₂H₄O)ₙ—SO₃M wherein R′ is a C₈-C₂₀ alkyl group, n is from about 1 to 20, and M is a salt-forming cation. In a specific embodiment, R′ is C₁₀-C₁₈ alkyl, n is from about 1 to 15, and M is sodium, potassium, ammonium, alkylammonium, or alkanolammonium. In more specific embodiments, R′ is a C₁₂-C₁₆, n is from about 1 to 6 and M is sodium.

The alkyl ether sulfates will generally be used in the form of mixtures comprising varying R′ chain lengths and varying degrees of ethoxylation. Frequently such mixtures will inevitably also contain some non-ethoxylated alkyl sulfate materials, i.e., surfactants of the above ethoxylated alkyl sulfate formula wherein n=0. Non-ethoxylated alkyl sulfates may also be added separately to the compositions of this invention and used as or in any anionic surfactant component which may be present. Specific examples of non-alkoyxylated, e.g., non-ethoxylated, alkyl ether sulfate surfactants are those produced by the sulfation of higher C₈-C₂₀ fatty alcohols. Conventional primary alkyl sulfate surfactants have the general formula: ROSO₃⁻M⁺ wherein R is typically a linear C₈-C₂₀ hydrocarbyl group, which may be straight chain or branched chain, and M is a water-solubilizing cation. In specific embodiments, R is a C₁₀-C₁₅ alkyl, and M is alkali metal, more specifically R is C₁₂-C₁₄ and M is sodium.

Specific, nonlimiting examples of anionic surfactants useful herein include: a) C₁₁-C₁₈ alkyl benzene sulfonates (LAS); b) C₁₀-C₂₀ primary, branched-chain and random alkyl sulfates (AS); c) C₁₀-C₁₈ secondary (2,3) alkyl sulfates having formulae (I) and (II):

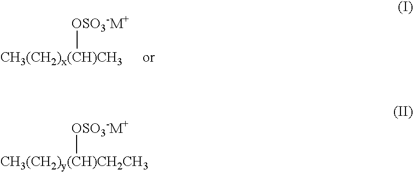

wherein M in formulae (I) and (II) is hydrogen or a cation which provides charge neutrality, and all M units, whether associated with a surfactant or adjunct ingredient, can either be a hydrogen atom or a cation depending upon the form isolated by the artisan or the relative pH of the system wherein the compound is used, with non-limiting examples of preferred cations including sodium, potassium, ammonium, and mixtures thereof, and x is an integer of at least about 7, preferably at least about 9, and y is an integer of at least 8, preferably at least about 9; d) C₁₀-C₁₈ alkyl alkoxy sulfates (AEₓS) wherein preferably x is from 1-30; e) C₁₀-C₁₈ alkyl alkoxy carboxylates preferably comprising 1-5 ethoxy units; f) mid-chain branched alkyl sulfates as discussed in U.S. Pat. No. 6,020,303 and U.S. Pat. No. 6,060,443; g) mid-chain branched alkyl alkoxy sulfates as discussed in U.S. Pat. No. 6,008,181 and U.S. Pat. No. 6,020,303; h) modified alkylbenzene sulfonate (MLAS) as discussed in WO 99/05243, WO 99/05242, WO 99/05244, WO 99/05082, WO 99/05084, WO 99/05241, WO 99/07656, WO 00/23549, and WO 00/23548.; i) methyl ester sulfonate (MES); and j) alpha-olefin sulfonate (AOS).

Suitable nonionic surfactants useful herein can comprise any of the conventional nonionic surfactant types typically used in liquid detergent products. These include alkoxylated fatty alcohols and amine oxide surfactants. Preferred for use in the liquid detergent products herein are those nonionic surfactants which are normally liquid.

Suitable nonionic surfactants for use herein include the alcohol alkoxylate nonionic surfactants. Alcohol alkoxylates are materials which correspond to the general formula: R¹(CₘH₂ₘO)ₙOH wherein R¹ is a C₈-C₁₆ alkyl group, m is from 2 to 4, and n ranges from about 2 to 12. Preferably R¹ is an alkyl group, which may be primary or secondary, that contains from about 9 to 15 carbon atoms, more preferably from about 10 to 14 carbon atoms. In one embodiment, the alkoxylated fatty alcohols will also be ethoxylated materials that contain from about 2 to 12 ethylene oxide moieties per molecule, more preferably from about 3 to 10 ethylene oxide moieties per molecule.

The alkoxylated fatty alcohol materials useful in the liquid detergent compositions herein will frequently have a hydrophilic-lipophilic balance (HLB) which ranges from about 3 to 17. More preferably, the HLB of this material will range from about 6 to 15, most preferably from about 8 to 15. Alkoxylated fatty alcohol nonionic surfactants have been marketed under the tradenames Neodol and Dobanol by the Shell Chemical Company.

Another suitable type of nonionic surfactant useful herein comprises the amine oxide surfactants. Amine oxides are materials which are often referred to in the art as “semi-polar” nonionics. Amine oxides have the formula: R(EO)ₓ(PO)_{y}(BO)_{z}N(O)(CH₂R′)₂.qH₂O. In this formula, R is a relatively long-chain hydrocarbyl moiety which can be saturated or unsaturated, linear or branched, and can contain from 8 to 20, preferably from 10 to 16 carbon atoms, and is more preferably C₁₂-C₁₆ primary alkyl. R′ is a short-chain moiety, preferably selected from hydrogen, methyl and —CH₂OH. When x+y+z is different from 0, EO is ethyleneoxy, PO is propyleneneoxy and BO is butyleneoxy. Amine oxide surfactants are illustrated by C₁₂₋₁₄ alkyldimethyl amine oxide.

Non-limiting examples of nonionic surfactants include: a) C₁₂-C₁₈ alkyl ethoxylates, such as, NEODOL® nonionic surfactants from Shell; b) C₆-C₁₂ alkyl phenol alkoxylates wherein the alkoxylate units are a mixture of ethyleneoxy and propyleneoxy units; c) C₁₂-C₁₈ alcohol and C₆-C₁₂ alkyl phenol condensates with ethylene oxide/propylene oxide block polymers such as Pluronic® from BASF; d) C₁₄-C₂₂ mid-chain branched alcohols, BA, as discussed in U.S. Pat. No. 6,150,322; e) C₁₄-C₂₂ mid-chain branched alkyl alkoxylates, BAEₓ, wherein x 1-30, as discussed in U.S. Pat. No. 6,153,577, U.S. Pat. No. 6,020,303 and U.S. Pat. No. 6,093,856; f) Alkylpolysaccharides as discussed in U.S. Pat. No. 4,565,647 Llenado, issued Jan. 26, 1986; specifically alkylpolyglycosides as discussed in U.S. Pat. No. 4,483,780 and U.S. Pat. No. 4,483,779; g) Polyhydroxy fatty acid amides as discussed in U.S. Pat. No. 5,332,528, WO 92/06162, WO 93/19146, WO 93/19038, and WO 94/09099; and h) ether capped poly(oxyalkylated) alcohol surfactants as discussed in U.S. Pat. No. 6,482,994 and WO 01/42408.

In the laundry detergent compositions herein, the detersive surfactant component may comprise combinations of anionic and nonionic surfactant materials. When this is the case, the weight ratio of anionic to nonionic will typically range from 10:90 to 90:10, more typically from 30:70 to 70:30.

Cationic surfactants are well known in the art and non-limiting examples of these include quaternary ammonium surfactants, which can have up to 26 carbon atoms. Additional examples include a) alkoxylate quaternary ammonium (AQA) surfactants as discussed in U.S. Pat. No. 6,136,769; b) dimethyl hydroxyethyl quaternary ammonium as discussed in U.S. Pat. No. 6,004,922; c) polyamine cationic surfactants as discussed in WO 98/35002, WO 98/35003, WO 98/35004, WO 98/35005, and WO 98/35006; d) cationic ester surfactants as discussed in U.S. Pat. Nos. 4,228,042, 4,239,660 4,260,529 and U.S. Pat. No. 6,022,844; and e) amino surfactants as discussed in U.S. Pat. No. 6,221,825 and WO 00/47708, specifically amido propyldimethyl amine (APA).

Non-limiting examples of zwitterionic surfactants include: derivatives of secondary and tertiary amines, derivatives of heterocyclic secondary and tertiary amines, or derivatives of quaternary ammonium, quaternary phosphonium or tertiary sulfonium compounds. See U.S. Pat. No. 3,929,678 to Laughlin et al., issued Dec. 30, 1975 at column 19, line 38 through column 22, line 48, for examples of zwitterionic surfactants; betaine, including alkyl dimethyl betaine and cocodimethyl amidopropyl betaine, C₈ to C₁₈ (preferably C₁₂ to C₁₈) amine oxides and sulfo and hydroxy betaines, such as N-alkyl-N,N-dimethylammino-1-propane sulfonate where the alkyl group can be C₈ to C₁₈, preferably C₁₀ to C₁₄.

Non-limiting examples of ampholytic surfactants include: aliphatic derivatives of secondary or tertiary amines, or aliphatic derivatives of heterocyclic secondary and tertiary amines in which the aliphatic radical can be straight- or branched-chain. One of the aliphatic substituents contains at least about 8 carbon atoms, typically from about 8 to about 18 carbon atoms, and at least one contains an anionic water-solubilizing group, e.g. carboxy, sulfonate, sulfate. See U.S. Pat. No. 3,929,678 to Laughlin et al., issued Dec. 30, 1975 at column 19, lines 18-35, for examples of ampholytic surfactants.

As used herein, “non-aminofunctional solvent” refers to any solvent which contains no amino functional groups. Non-aminofunctional solvent include, for example: water, C₁-C₅ alkanols such as methanol, ethanol, propanol and 1-ethoxypentanol; C₂-C₆ diols; C₃-C₈ alkylene glycols; C₃-C₈ alkylene glycol mono lower alkyl ethers; glycol dialkyl ether; lower molecular weight polyethylene glycols; C₃-C₉ triols such as glycerol; and mixtures thereof. More specifically non-aminofunctional solvent are liquids at ambient temperature and pressure (i.e. 21° C. and 1 atmosphere), and comprise carbon, hydrogen and oxygen.

Generally in noncompacted product formulations, all non-aminofunctional solvent, including water, may comprise from about 5% to about 90%, more specifically from about 10% to about 70%, and even more specifically from about 20% to about 60%. Recently developed compacted liquid detergent formulae may comprise no more than about 50%, more specifically no more than 35%, more specifically still no more than 30%, even more specifically still no more than 25%, by weight of the composition, and specifically having about 0% to 45%, specifically 1% to 30%, more specifically from about 2% to about 25%, more specifically from about 3% to about 20%, more specifically still from about 5% to about 15%, by weight of the composition, of the non-aminofunctional solvent.

The most cost effective type of non-aminofunctional solvent is, of course, water itself. Accordingly, the non-aminofunctional solvent will generally be mostly, if not completely, comprised of water. While other types of water-miscible liquids, such as alkanols, diols, other polyols, ethers, amines, and the like, have been conventionally been added to liquid detergent compositions as co-solvents or stabilizers, the utilization of such water-miscible liquids should be minimized to hold down composition cost.

The liquid detergent compositions of the present invention can also include any number of additional optional ingredients. These include conventional laundry detergent composition components such as detersive builders, enzymes, enzyme stabilizers (such as propylene glycol, boric acid and/or borax), suds suppressors, soil suspending agents, soil release agents, other fabric care benefit agents, pH adjusting agents, chelating agents, smectite clays, solvents, hydrotropes and phase stabilizers, structuring agents, dye transfer inhibiting agents, optical brighteners, perfumes and coloring agents. The various optional detergent composition ingredients, if present in the compositions herein, should be utilized at concentrations conventionally employed to bring about their desired contribution to the composition or the laundering operation. Frequently, the total amount of such optional detergent composition ingredients can range from about 0.1% to about 50%, more preferably from about 1% to about 30%, by weight of the composition.

Specifically it has been found that combinations of the polyacrylic acid based polymer with certain previously known polymer additive provide improved benefits.

The polyacrylic based polymer may be beneficially combined with the water soluble or dispersible, modified polyamine soil release polymers. Such polymers are discussed in U.S. Pat. No. 3,087,316. These polyamines comprise backbones that can be either linear or cyclic. The polyamine backbones can also comprise polyamine branching chains to a greater or lesser degree. In general, the polyamine backbones described herein are modified in such a manner that each nitrogen of the polyamine chain is thereafter described in terms of a unit that is substituted, quaternized, oxidized, or combinations thereof.

For the purposes of the present invention the term “modification” is defined as replacing a backbone —NH hydrogen atom by an E unit (substitution), quaternizing a backbone nitrogen (quaternized) or oxidizing a backbone nitrogen to the N-oxide (oxidized). The terms “modification” and “substitution” are used interchangably when referring to the process of replacing a hydrogen atom attached to a backbone nitrogen with an E unit. Quaternization or oxidation may take place in some circumstances without substitution, but substitution must be accompanied by oxidation or quaternization of at least one backbone nitrogen.

The linear or non-cyclic polyamine backbones that comprise the cotton soil release agents of the present invention have the general formula:

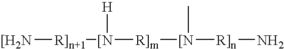

said backbones prior to subsequent modification, comprise primary, secondary and tertiary amine nitrogens connected by R “linking” units. The cyclic polyamine backbones comprising the cotton soil release agents of the present invention have the general formula:

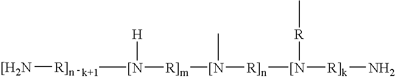

said backbones prior to subsequent modification, comprise primary, secondary and tertiary amine nitrogens connected by R “linking” units

For the purpose of the present invention, primary amine nitrogens comprising the backbone or branching chain once modified are defined as V or Z “terminal” units. For example, when a primary amine moiety, located at the end of the main polyamine backbone or branching chain having the structure

H₂N—R]—

is modified according to the present invention, it is thereafter defined as a V “terminal” unit, or simply a V unit. However, for the purposes of the present invention, some or all of the primary amine moieties can remain unmodified subject to the restrictions further described herein below. These unmodified primary amine moieties by virtue of their position in the backbone chain remain “terminal” units. Likewise, when a primary amine moiety, located at the end of the main polyamine backbone having the structure

—NH₂

is modified according to the present invention, it is thereafter defined as a Z “terminal” unit, or simply a Z unit. This unit can remain unmodified subject to the restrictions further described herein below.

In a similar manner, secondary amine nitrogens comprising the backbone or branching chain once modified are defined as W “backbone” units. For example, when a secondary amine moiety, the major constituent of the backbones and branching chains of the present invention, having the structure

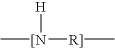

is modified according to the present invention, it is thereafter defined as a W “backbone” unit, or simply a W unit. However, for the purposes of the present invention, some or all of the secondary amine moieties can remain unmodified, but according to the present invention some backbone units must be modified. These unmodified secondary amine moieties by virtue of their position in the backbone chain remain “backbone” units.

In a further similar manner, tertiary amine nitrogens comprising the backbone or branching chain once modified are further referred to as Y “branching” units. For example, when a tertiary amine moiety, which is a chain branch point of either the polyamine backbone or other branching chains or rings, having the structure

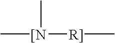

is modified according to the present invention, it is thereafter defined as a Y “branching” unit, or simply a Y unit. However, for the purposes of the present invention, some or all or the tertiary amine moieties can remain unmodified. These unmodified tertiary amine moieties by virtue of their position in the backbone chain remain “branching” units. The R units associated with the V, W and Y unit nitrogens which serve to connect the polyamine nitrogens, are described herein below.

The final modified structure of the polyamines of the present invention can be therefore represented by the general formula

V₍ₙ₊₁₎WₘYₙZ

for linear or branched polyamine cotton soil release polymers and by the general formula

V₍ₙ₋ₖ₊₁₎WₘYₙY′ₖZ

for cyclic polyamine cotton soil release polymers. For the case of polyamines comprising rings, a Y′ unit of the formula

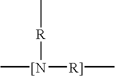

serves as a branch point for a backbone or branch ring. Except in the cases wherein the backbone comprises a ring, then for every Y′ unit there is a Y unit having the formula

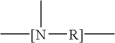

that will form the connection point of the ring to the main polymer chain or branch. In the unique case where the backbone is a complete ring, the polyamine backbone has the formula

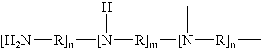

therefore comprising no Z terminal unit and having the formula

Vₙ₋ₖWₘYₙY′ₖ

wherein k is the number of ring forming branching units.

In the case of non-cyclic polyamines, the ratio of the index n to the index m relates to the relative degree of branching. A fully non-branched linear modified polyamine according to the present invention has the formula

VWₘZ

that is, n is equal to 0. The greater the value of n (the lower the ratio of m to n), the greater the degree of branching in the molecule. Typically the value for m ranges from a minimum value of 4 to about 400, however larger values of m, especially when the value of the index n is very low or nearly 0, are also preferred. As further defined herein below, when the ratio of m:n is approximately 2:1 m is preferably less than 200.

Each polyamine nitrogen whether primary, secondary or tertiary, once modified according to the present invention, is further defined as being a member of one of three general classes; simple substituted, quaternized or oxidized. Those polyamine nitrogen units not modified are classed into V, W, Y, or Z units depending on whether they are primary, secondary or tertiary nitrogens. That is unmodified primary amine nitrogens are V or Z units, unmodified secondary amine nitrogens are W units and unmodified tertiary amine nitrogens are Y units for the purposes of the present invention.

Modified primary amine moieties are defined as V “terminal” units having one of three forms:

a) simple substituted units having the structure:

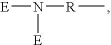

b) quaternized units having the structure:

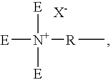

wherein X is a suitable counter ion providing charge balance; and

c) oxidized units having the structure:

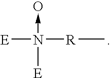

Modified secondary amine moieties are defined as W “backbone” units having one of three forms:

a) simple substituted units having the structure:

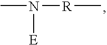

b) quaternized units having the structure:

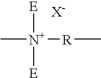

wherein X is a suitable counter ion providing charge balance; and

c) oxidized units having the structure:

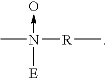

Modified tertiary amine moieties are defined as Y “branching” units having one of three forms:

a) unmodified units having the structure:

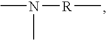

b) quaternized units having the structure:

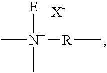

wherein X is a suitable counter ion providing charge balance; and

c) oxidized units having the structure:

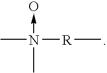

Certain modified primary amine moieties are defined as Z “terminal” units having one of three forms:

a) simple substituted units having the structure:

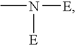

b) quaternized units having the structure:

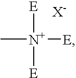

wherein X is a suitable counter ion providing charge balance; and

c) oxidized units having the structure:

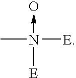

When any position on a nitrogen is unsubstituted of unmodified, it is understood that hydrogen will substitute for E. For example, a primary amine unit comprising one E unit in the form of a hydroxyethyl moiety is a V terminal unit having the formula (HOCH₂CH₂)HN—.

For the purposes of the present invention there are two types of chain terminating units, the V and Z units. The Z “terminal” unit derives from a terminal primary amino moiety of the structure —NH₂. Non-cyclic polyamine backbones according to the present invention comprise only one Z unit whereas cyclic polyamines can comprise no Z units. The Z “terminal” unit can be substituted with any of the E units described further herein below, except when the Z unit is modified to form an N-oxide. In the case where the Z unit nitrogen is oxidized to an N-oxide, the nitrogen must be modified and therefor E cannot be a hydrogen.

The polyamines of the present invention comprise backbone R units that serve to connect the nitrogen atoms of the backbone. R units comprise units that for the purposes of the present invention are referred to as “hydrocarbyl R” units and “oxy R” units. The “hydrocarbyl” R units are C₂-C₁₂ alkylene, preferably ethylene, 1,2-propylene, and mixtures thereof, more preferably ethylene. The “oxy” R units comprise —(R¹O)ₓR³(OR¹)ₓ—, —CH₂CH(OR²)CH₂O)_{z}(R¹O)_{y}R¹O —(CH₂CH(OR²)CH₂)_{w}—, —CH₂CH(OR²)CH₂—, and mixtures thereof; preferred “oxy” R units are —CH₂CH(OR²)CH₂—, —(CH₂CH(OH)CH₂O)_{z}(R¹O)_{y}R¹—O(CH₂CH(OH)CH₂)_{w}—, and mixtures thereof. The backbone R units of the present invention must comprise at least one —CH₂CH(OR²)CH₂—, —(CH₂CH(OH)CH₂O)_{z}—(R¹O)_{y}R¹O(CH₂CH(OH)CH₂)_{w}—, —CH₂CH(OR²)CH₂—, or mixtures thereof.

R¹ units are C₂-C₆ alkylene, and mixtures thereof, preferably ethylene.

R² is hydrogen, and —(R¹O)ₓB, preferably hydrogen.

R³ is C₁-C₁₂ alkylene, C₃-C₁₂ hydroxyalkylene, C₄-C₁₂ dihydroxyalkylene, C₈-C₁₂ dialkylarylene, —C(O)—, —C(O)NHR⁶NHC(O)—, —C(O)(R⁴)ᵣC(O)—, —R¹(OR¹)—, —CH₂CH(OH)CH₂O(R¹O)_{y}R¹OCH₂CH(OH)CH₂—, —C(O)(R⁴)ᵣC(O)—, —CH₂CH(OH)CH₂—, R³ is preferably ethylene, —C(O)—, —C(O)NHR⁵NHC(O)—, 13 R¹(OR¹)—, —CH₂CH(OH)CH₂—, —CH₂CH(OH)CH₂O(R¹O)_{y}R¹OCH₂CH—(OH)CH₂—, more preferably —CH₂CH(OH)CH₂—.

R⁴ is C₁-C₁₂ alkylene, C₄-C₁₂ alkenylene, C₈-C₁₂ arylalkylene, C₆-C₁₀ arylene, preferably C₁-C₁₀ alkylene, C₈-C₁₂ arylalkylene, more preferably C₂-C₈ alkylene, most preferably ethylene or butylene.

R⁵ is C₂-C₁₂ alkylene or C₆-C₁₂ arylene

The preferred “oxy” R units are further defined in terms of the R¹, R², and R³ units. Preferred “oxy” R units comprise the preferred R¹, R², and R³ units. The preferred cotton soil release agents of the present invention comprise at least 50% R¹ units that are ethylene. Preferred R¹, R², and R³ units are combined with the “oxy” R units to yield the preferred “oxy” R units in the following manner.
i) Substituting more preferred R³ into —(CH₂CH₂O)ₓR³(OCH₂CH₂)ₓ— yields —(CH₂CH₂O)ₓCH₂CHOHCH₂(OCH₂CH₂)ₓ—.
ii) Substituting preferred R¹ and R² into —(CH₂CH(OR²)CH₂O)_{z}—(R¹O)_{y}R¹O(CH₂CH(OR²)CH₂)_{w}— yields —(CH₂CH(OH)CH₂O)_{z}—(CH₂CH₂O)_{y}CH₂CH₂O(CH₂CH(OH)CH₂)_{w}—.
iii) Substituting preferred R² into —CH₂CH(OR²)CH₂— yields

—CH₂CH(OH)CH₂—.

E units are selected from the group consisting of —(CH₂)ₚCO₂M, —(CH₂)_{q}—SO₃M, —CH(CH₂CO₂M)CO₂M, —(CH₂)ₚPO₃M, —(R¹O)ₓB, preferably —(R¹O)ₓB, —(CH₂)ₚCO₂M, —(CH₂)_{q}SO₃M, CH(CH₂CO₂M)CO₂M, more preferably —(R¹O)ₓB. When no modification or substitution is made on a nitrogen then hydrogen atom will remain as the moiety representing E.

E units do not comprise hydrogen atom when the V, W or Z units are oxidized, that is the nitrogens are N-oxides. For example, the backbone chain or branching chains do not comprise units of the following structure:

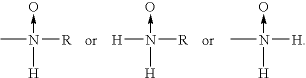

B is hydrogen, —(CH₂)ₚCO₂M, —(CH₂)_{q}SO₃M, —(CH₂)_{q}CH(SO₃M)-CH₂SO₃M, —(CH₂)_{q}CH(SO₂M)CH₂SO₃M, —(CH₂)ₚPO₃M, —PO₃M, preferably hydrogen, —(CH₂)_{q}SO₃M, —(CH₂)_{q}CH(SO₃M)CH₂SO₃M, —(CH₂)_{q}CH(SO₂M)-CH₂SO₃M, more preferably hydrogen or —(CH₂)_{q}SO₃M.

M is hydrogen or a water soluble cation in sufficient amount to satisfy charge balance. For example, a sodium cation equally satisfies —(CH₂)ₚCO₂M, and —(CH₂)_{q}SO₃M, thereby resulting in —(CH₂)ₚCO₂Na, and —(CH₂)_{q}SO₃Na moieties. More than one monovalent cation, (sodium, potassium, etc.) can be combined to satisfy the required chemical charge balance. However, more than one anionic group may be charge balanced by a divalent cation, or more than one mono-valent cation may be necessary to satisfy the charge requirements of a poly-anionic radical. For example, a —(CH₂)ₚPO₃M moiety substituted with sodium atoms has the formula —(CH₂)ₚPO₃Na₂. Divalent cations such as calcium (Ca²⁺) or magnesium (Mg²⁺) may be substituted for or combined with other suitable mono-valent water soluble cations. Preferred cations are sodium and potassium, more preferred is sodium.

X is a water soluble anion such as chlorine (Cl⁻), bromine (Br⁻) and iodine (I⁻) or X can be any negatively charged radical such as sulfate (SO₄²⁻), methosulfate (CH₃OSO₃⁻), and methanesulfonate (CH₃SO₃⁻).

The formula indices have the following values: p has the value from 1 to 6; q has the value from 0 to 6; r has the value 0 or 1; w has the value 0 or 1; x has the value from 1 to 100; y has the value from 0 to 100; z has the value 0 or 1; k has the value from 0 to about 20; m has the value from 4 to about 400; n has the value from 0 to about 200; preferably m+n has the value of at least 5.

The preferred cotton soil release agents of the present invention comprise polyamine backbones wherein less than about 100% of the R groups comprise “oxy” R units, preferably less than about 50%, more preferably less than 30%, most preferably less than about 20% of the R units comprise “oxy” R units.

The preferred cotton soil release agents of the present invention comprise polyamine backbones wherein less than 50% of the “hydrocarbyl” R groups comprise more than 3 carbon atoms. For example, ethylene, 1,2-propylene, and 1,3-propylene comprise 3 or less carbon atoms and are the preferred “hydrocarbyl” R units. That is when backbone R units are C₂-C₁₂ alkylene, preferred is C₂-C₃ alkylene, most preferred is ethylene.

The cotton soil release agents of the present invention comprise modified non-homogeneous polyamine backbones, wherein 100% or less of the —NH units are modified. For the purpose of the present invention the term “homogeneous polyamine backbone” is defined as a polyamine backbone having R units that are the same (i.e., all ethylene). However, this sameness definition does not exclude polyamines that comprise other extraneous units comprising the polymer backbone which are present due to an artifact of the chosen method of chemical synthesis. For example, it is known to those skilled in the art that ethanolamine may be used as an “initiator” in the synthesis of polyethyleneimines, therefore a sample of polyethyleneimine that comprises one hydroxyethyl moiety resulting from the polymerization “initiator” would be considered to comprise a homogeneous polyamine backbone for the purposes of the present invention.

For the purposes of the present invention the term “non-homogeneous polymer backbone” refers to polyamine backbones that are a composite of various R unit lengths and R unit types. The proper manipulation of these “R unit chain lengths” provides the formulator with the ability to modify the solubility and fabric substantivity of the cotton soil release agents of the present invention.

An example of a polyamine backbone according to the present invention prior to modification has the formula

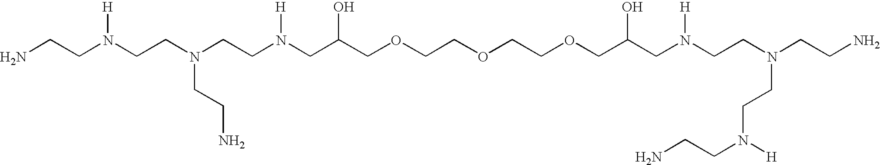

wherein 8 R units comprise ethylene units and 1 R unit comprises a

—CH₂CH(OH)CH₂O(R¹O)_{y}R¹OCH₂CH(OH)CH₂—

moiety wherein R¹ is ethylene and y is equal to 1.

A further example of a polyamine backbone prior to modification that is suitable for use as a cotton soil release agent according to the present invention has the formula

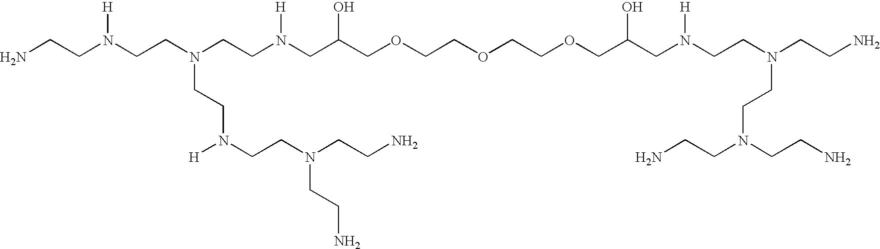

wherein 12 R units comprise ethylene units and 1 R unit comprises a

—CH₂CH(OH)CH₂O(R¹O)_{y}R¹OCH₂CH(OH)CH₂—

moiety wherein R¹ is ethylene and y is equal to 1. Structures similar to these two examples given above are for the purposes of the present invention commonly referred to as “blocks”. Typically several blocks are combined to form the final backbone prior to modification.

As in the examples above, polyethyleneimines (PEI's) and polyethyleneamines (PEA's) of low molecular weight, typically below 600 daltons, are linked together using the “oxy” R units which serve as convenient coupling agents. Depending on the desired properties of the final cotton soil release agent (e.g., solubility, fabric substantivity) a lesser or greater degree of “oxy” R units will comprise the polyamine backbone.

It is more convenient for nitrogen modification to occur after complete assembly of the polyamine backbone. However the formulator may wish to have a polymer backbone with a high degree of unmodified nitrogen atoms. This can be accomplished by pre-modifying some or all or the polyalkyleneimine or polyalkyleneamine “hydrocarbyl” portion of the backbone prior to linking via “oxy” R units.

An example of a procedure that allows for a mixture of modified and unmodified blocks in the cotton soil release polymer, comprises the steps of
i) modifying a polyethyleneimine having, for example, the formula:

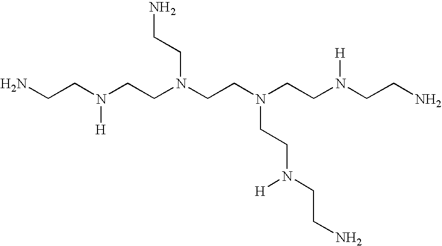

wherein the modification is
a) substitution of the —NH hydrogen atom by an E unit;
b) quaternization;
c) oxidation to the N-oxide; or
d) mixtures thereof;
   resulting in an example modified polyethyleneimine having the formula:

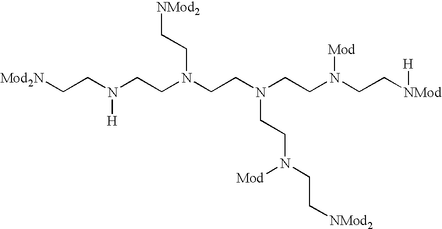

wherein Mod represents one or more modifications according to the present invention; the modified polyethyleneimine is coupled with a second molecule of the original unmodified polyethyleneimine through an —CH₂CH(OH)CH₂O(R¹O)_{y}R¹OCH₂CH(OH)CH₂— moiety wherein R¹ is ethylene and y is equal to 1, to form a polyamine cotton soil release agent having the formula:

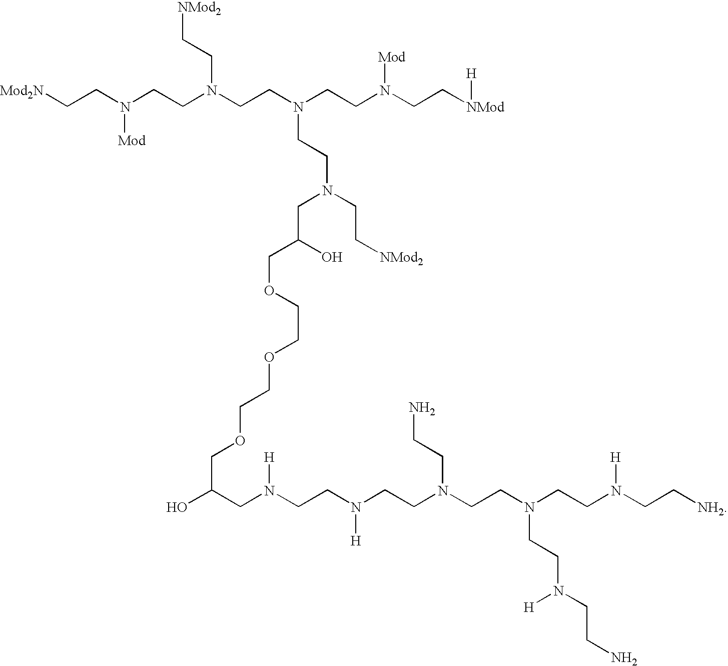

Once this process is completed, the above unit may be used “as is” or may be further coupled to one or more modified or unmodified blocks.

The preferred “blocks” of polyamines having “hydrocarbyl” R units that comprise the backbone of the compounds of the present invention are generally polyalkyleneamines (PAA's), polyalkyleneimines (PAI's), preferably polyethyleneamine (PEA's), polyethyleneimines (PEI's) units. An example of a polyalkyleneamine (PAA) is tetrabutylenepentamine. PEA's are obtained by reactions involving ammonia and ethylene dichloride, followed by fractional distillation. The common PEA's obtained are triethylenetetramine (TETA) and teraethylenepentamine (TEPA). Above the pentamines, i.e., the hexamines, heptamines, octamines and possibly nonamines, the cogenerically derived mixture does not appear to separate by distillation and can include other materials such as cyclic amines and particularly piperazines. There can also be present cyclic amines with side chains in which nitrogen atoms appear. See U.S. Pat. No. 2,792,372, Dickinson, issued May 14, 1957, which describes the preparation of PEA's.

The PEI blocks which comprise the preferred backbones of the polyamines of the present invention can be prepared, for example, by polymerizing ethyleneimine in the presence of a catalyst such as carbon dioxide, sodium bisulfite, sulfuric acid, hydrogen peroxide, hydrochloric acid, acetic acid, etc. Specific methods for preparing PEI's are disclosed in U.S. Pat. No. 2,182,306, Ulrich et al., issued Dec. 5, 1939; U.S. Pat. No. 3,033,746, Mayle et al., issued May 8, 1962; U.S. Pat. No. 2,208,095, Esselmann et al., issued Jul. 16, 1940; U.S. Pat. No. 2,806,839, Crowther, issued Sep. 17, 1957; and U.S. Pat. No. 2,553,696, Wilson, issued May 21, 1951 (all herein incorporated by reference). In addition to the linear and branched PEI's, the present invention also includes the cyclic amines that are typically formed as artifacts of synthesis. The presence of these materials may be increased or decreased depending on the conditions chosen by the formulator.

However, polyamine backbones of the present invention may comprise 100% “oxy” moieties, for example, a polyamine backbone prior to modification comprising —CH₂CH(OH)CH₂O(R¹O)_{y}R¹OCH₂CH(OH)CH₂— R units wherein R¹ is ethylene and y is equal to 1, has the formula

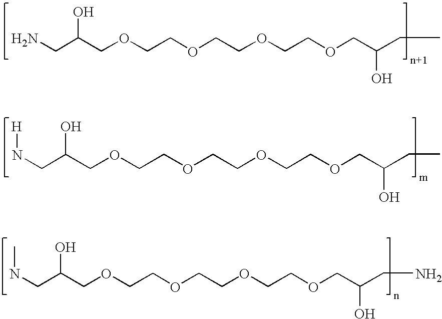

An example of a soil release agent according to the present invention has the formula:

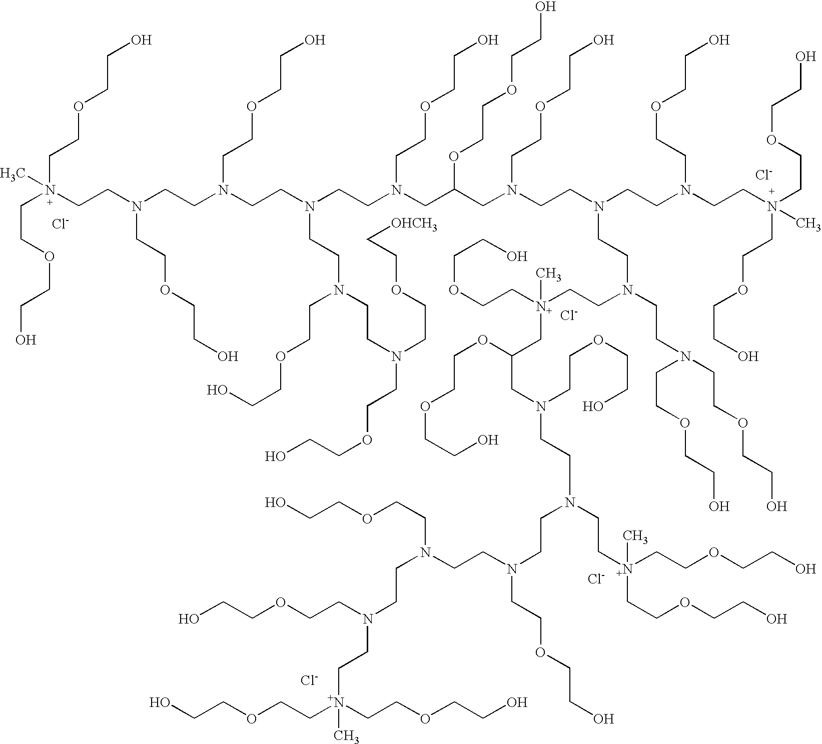

wherein R units are ethylene and —CH₂CH[(CH₂CH₂O)₂H]CH₂— and the E units are —(CH₂CH₂O)₂H and —CH₃.
Preferred, but non-limiting, examples of polyamine-based polymers of the present invention are shown below—PEI₆₀₀(EO)₁₀(PO)₇ and PEI₆₀₀(EO)₂₀, respectively.

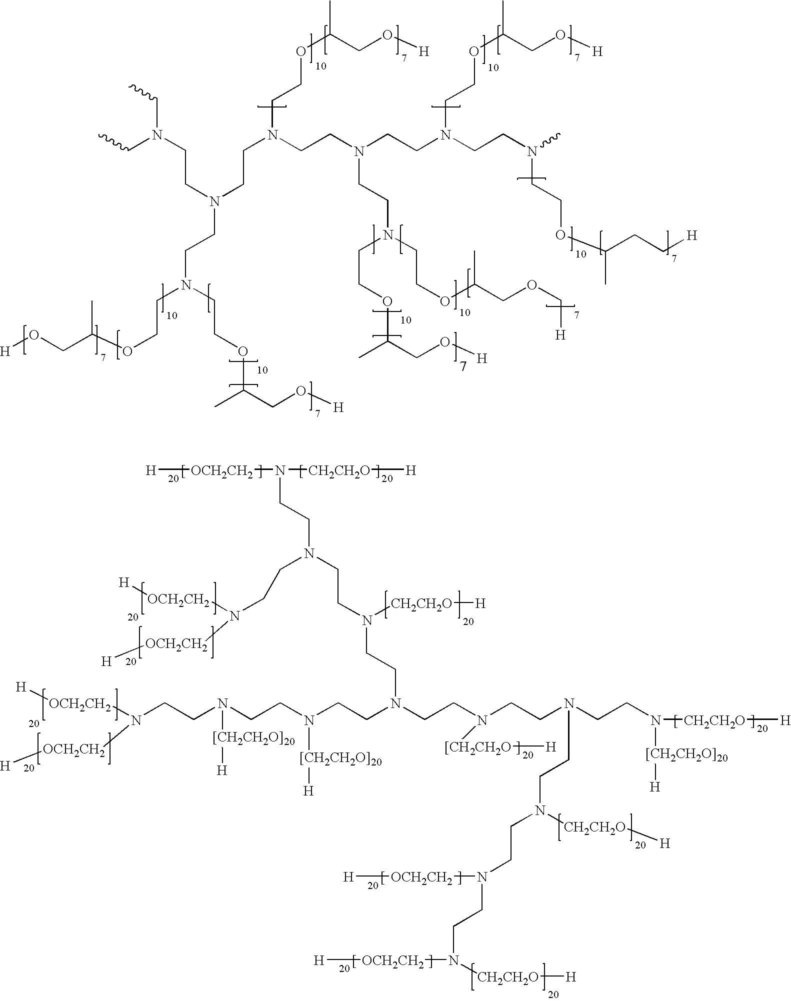

The polyacrylic acid based polymers of the present invention may also be beneficially combined with zwitterionic polyamine additives disclosed in U.S. Pat. No. 6,660,711. These zwitterionic polyamines of the present invention have the formula:

[J-R]ₙ-J

wherein the [J-R] units represent the amino units which comprise the main backbone and any branching chains. Preferably the zwitterionic polyamines prior to modification, inter alia, quaternization, substitution of an amino unit hydrogen with an alkyleneoxy unit, have backbones which comprise from 2 to about 100 amino units. The index n which describes the number of backbone units present is further described herein below.

J units are the backbone amino units, said units are selected from the group consisting of:
i) primary amino units having the formula:

(R¹)₂N;
ii) secondary amino units having the formula:

—R¹N;
iii) tertiary amino units having the formula:

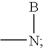

iv) primary quaternary amino units having the formula:

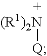

v) secondary quaternary amino units having the formula:

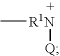

vi) tertiary quaternary amino units having the formula:

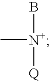

vii) primary N-oxide amino units having the formula:

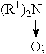

viii) secondary N-oxide amino units having the formula:

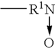

ix) tertiary N-oxide amino units having the formula:

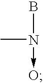

x) and mixtures thereof.

B units which have the formula:

[J-R]—

represent a continuation of the zwitterionic polyamine backbone by branching. The number of B units present, as well as, any further amino units which comprise the branches are reflected in the total value of the index n.

The backbone amino units of the zwitterionic polymers are connected by one or more R units, said R units are selected from the group consisting of:
i) C₂-C₁₂ linear alkylene, C₃-C₁₂ branched alkylene, or mixtures thereof; preferably C₃-C₆ alkylene. When two adjacent nitrogens of the polyamine backbone are N-oxides, preferably the alkylene backbone unit which separates said units are C₄ units or greater.
ii) alkyleneoxyalkylene units having the formula:

—(R²O)_{w}(R³)—
wherein R² is selected from the group consisting of ethylene, 1,2-propylene, 1,3-propylene, 1,2-butylene, 1,4-butylene, and mixtures thereof; R³ is C₂-C₈ linear alkylene, C₃-C₈ branched alkylene, phenylene, substituted phenylene, and mixtures thereof; the index w is from 0 to about 25. R² and R³ units may also comprise other backbone units. When comprising alkyleneoxyalkylene units, in one embodiment R² and R³ units are each preferably ethylene or mixtures of ethylene, propylene and butylene, more preferably ethylene; in another embodiment R² and R³ units are preferably mixtures of ethylene, propylene and butylene; the index w is from 1, preferably from about 2 to about 10, preferably to about 6.
iii) hydroxyalkylene units having the formula:

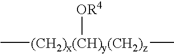

wherein R⁴ is hydrogen, C₁-C₆ alkyl, —(CH₂)ᵤ(R²O)ₜ(CH₂)ᵤY, and mixtures thereof. When R units comprise hydroxyalkylene units, R⁴ is preferably hydrogen or —(CH₂)ᵤ(R²O)ₜ(CH₂)ᵤY wherein the index t is greater than 0, preferably from 10 to 30; the index u is from 0 to 6; and Y is preferably hydrogen or an anionic unit, more preferably —SO₃M. The indices x, y, and z are each independently from 1 to 6, preferably the indices are each equal to 1 and R⁴ is hydrogen (2-hydroxypropylene unit) or (R²O)ₜY, or for polyhydroxy units y is preferably 2 or 3. A preferred hydroxyalkylene unit is the 2-hydroxypropylene unit which can, for example, be suitably formed from glycidyl ether forming reagents, inter alia, epihalohydrin.
iv) hydroxyalkylene/oxyalkylene units having the formula:

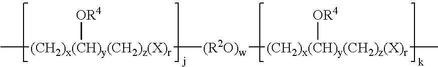

wherein R², R⁴, and the indices w, x, y, and z are the same as defined herein above. X is oxygen or the amino unit —NR⁴—, the index r is 0 or 1. The indices j and k are each independently from 1 to 20. When alkyleneoxy units are absent the index w is 0. Non-limiting examples of
preferred hydroxyalkylene/oxyalkylene units have the formula:

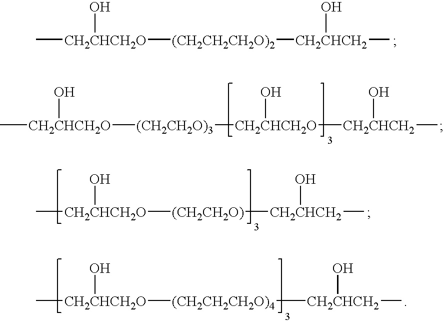

v) carboxyalkyleneoxy units having the formula:

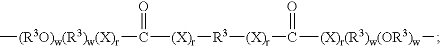

wherein R², R³, X, r, and w are the same as defined herein above. Non-limiting examples of preferred carboxyalkyleneoxy units include:

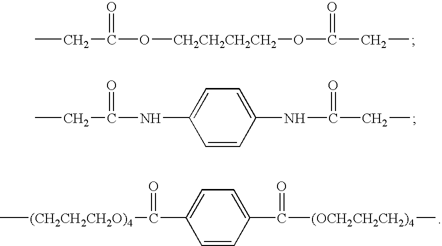

vi) backbone branching units having the formula:

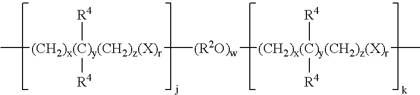

wherein R⁴ is hydrogen, C₁-C₆ alkyl, —(CH₂)ᵤ(R²O)ₜ(CH₂)ᵤY, and mixtures thereof. When R units comprise backbone branching units, R⁴ is preferably hydrogen or —(CH₂)ᵤ(R²O)ₜ—(CH₂)ᵤY wherein the index t is greater than 0, preferably from 10 to 30; the index u is from 0 to 6; and Y is hydrogen, C₁-C₄ linear alkyl, —N(R¹)₂, an anionic unit, and mixtures thereof; preferably Y is hydrogen, or —N(R¹)₂. A preferred embodiment of backbone branching units comprises R⁴ equal to —(R²O)ₜH. The indices x, y, and z are each independently from 0 to 6.
vii) The formulator may suitably combine any of the above described R units to make a zwitterionic polyamine having a greater or lesser degree of hydrophilic character.

R¹ units are the units which are attached to the backbone nitrogens. R¹ units are selected from the group consisting of:
i) hydrogen; which is the unit typically present prior to any backbone modification.
ii) C₁-C₂₂ alkyl, preferably C₁-C₄ alkyl, more preferably methyl or ethyl, most preferably methyl. A preferred embodiment of the present invention in the instance wherein R¹ units are attached to quaternary units (iv) or (v), R¹ is the same unit as quaternizing unit Q. For example a J unit having the formula:

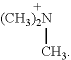

iii) C₇-C₂₂ arylalkyl, preferably benzyl.
iv) —[CH₂CH(OR⁴)CH₂O]ₛ(R²O)ₜY; wherein R² and R⁴ are the same as defined herein above, preferably when R¹ units comprise R² units, R² is preferably ethylene. The value of the index s is from 0 to 5. For the purposes of the present invention the index t is expressed as an average value, said average value from about 0.5 to about 100. The formulator may lightly alkyleneoxylate the backbone nitrogens in a manner wherein not every nitrogen atom comprises an R¹ unit which is an alkyleneoxy unit thereby rendering the value of the index t less than 1.
v) Anionic units as described herein below.
vi) The formulator may suitably combine one or more of the above described R¹ units when substituting the backbone of the zwitterionic polymers of the present invention.

Q is a quaternizing unit selected from the group consisting of C₁-C₄ linear alkyl, benzyl, and mixtures thereof, preferably methyl. As described herein above, preferably Q is the same as R¹ when R¹ comprises an alkyl unit. For each backbone N⁺ unit (quaternary nitrogen) there will be an anion to provide charge neutrality. The anionic groups of the present invention include both units which are covalently attached to the polymer, as well as, external anions which are present to achieve charge neutrality. Non-limiting examples of anions suitable for use include halogen, inter alia, chloride; methyl sulfate; hydrogen sulfate, and sulfate. The formulator will recognize by the herein described examples that the anion will typically be a unit which is part of the quaternizing reagent, inter alia, methyl chloride, dimethyl sulfate, benzyl bromide.

X is oxygen, —NR⁴—, and mixtures thereof, preferably oxygen.

Y is hydrogen, C₁-C₄ linear alkyl, —N(R¹)₂, or an anionic unit. Y is —N(R¹)₂ preferably when Y is part of an R unit which is a backbone branching unit. Anionic units are defined herein as “units or moieties which are capable of having a negative charge”. For example, a carboxylic acid unit, —CO₂H, is neutral, however upon de-protonation the unit becomes an anionic unit, —CO₂⁻, the unit is therefore, “capable of having a negative charge. Non-limiting examples of anionic Y units include —(CH₂)_{f}CO₂M, —C(O)(CH₂)_{f}CO₂M, —(CH₂)_{f}PO₃M, —(CH₂)_{f}OPO₃M, —(CH₂)_{f}SO₃M, —CH₂(CHSO₃M)-(CH₂)_{f}SO₃M, —CH₂(CHSO₂M)(CH₂)_{f}SO₃M, —C(O)CH₂CH(SO₃M)CO₂M, —C(O)CH₂CH(CO₂M)NHCH(CO₂M)CH₂CO₂M, —C(O)CH₂CH(CO₂M)NHCH₂CO₂M, —CH₂CH(OZ)CH₂O(R¹O)ₜZ, —(CH₂)_{f}CH[O(R²O)ₜZ]—CH_{f}O(R²O)ₜZ, and mixtures thereof, wherein Z is hydrogen or an anionic unit non-limiting examples of which include —(CH₂)_{f}CO₂M, —C(O)(CH₂)_{f}CO₂M, —(CH₂)_{f}PO₃M, —(CH₂)_{f}OPO₃M, —(CH₂)_{f}SO₃M, —CH₂(CHSO₃M)-(CH₂)_{f}SO₃M, —CH₂(CHSO₂M)(CH₂)_{f}SO₃M, —C(O)CH₂CH(SO₃M)CO₂M, —C(O)CH₂CH(CO₂M)NHCH(CO₂M)CH₂CO₂M, and mixtures thereof, M is a cation which provides charge neutrality.

Y units may also be oligomeric or polymeric, for example, the anionic Y unit having the formula:

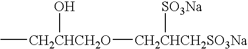

may be oligomerized or polymerized to form units having the general formula:

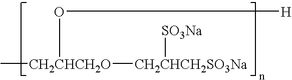

wherein the index n represents a number greater than 1.

Further non-limiting examples of Y units which can be suitably oligomerized or polymerized include:

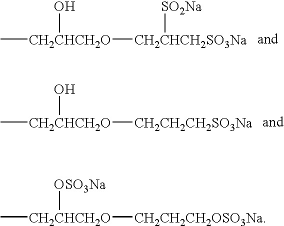

As described herein above that a variety of factors, inter alia, the overall polymer structure, the nature of the formulation, the wash conditions, and the intended target cleaning benefit, all can influence the formulator's optimal values for Qᵣ, ΔQ, and Q(+).

For liquid laundry detergent compositions preferably less than about 90%, more preferably less than 75%, yet more preferably less than 50%, most preferably less than 40% of said Y units comprise an anionic moiety, inter alia, —SO₃M comprising units. The number of Y units which comprise an anionic unit will vary from embodiment to embodiment. M is hydrogen, a water soluble cation, and mixtures thereof; the index f is from 0 to 6.

The index n represents the number of backbone units wherein the number of amino units in the backbone is equal to n+1. For the purposes of the present invention the index n is from 1 to about 99. Branching units B are included in the total number of backbone units.

The following non-limiting examples indicate the manner in which the backbones of the present polyamines are assembled and defined.

The following is an non-limiting example of a backbone according to the present invention prior to quatrernization:

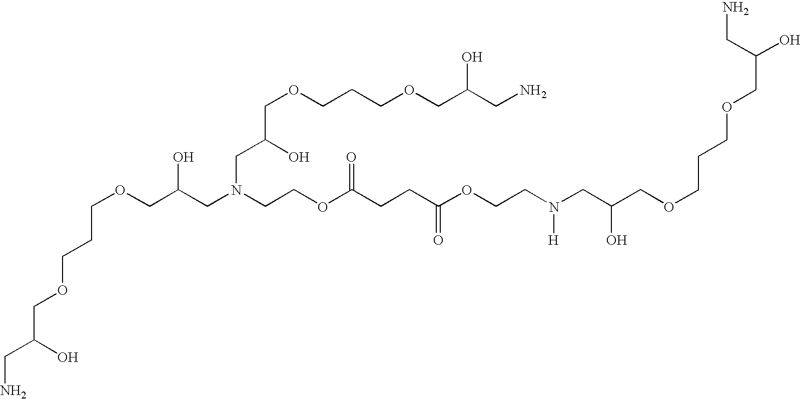

which has an index n equal to 4.

The following is also a non-limiting example of a backbone according to the present invention prior to quatrernization:

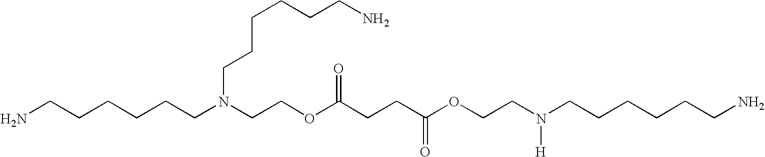

which has an index n equal to 4.

The following is a non-limiting example of a polyamine backbone which is fully quaternized.

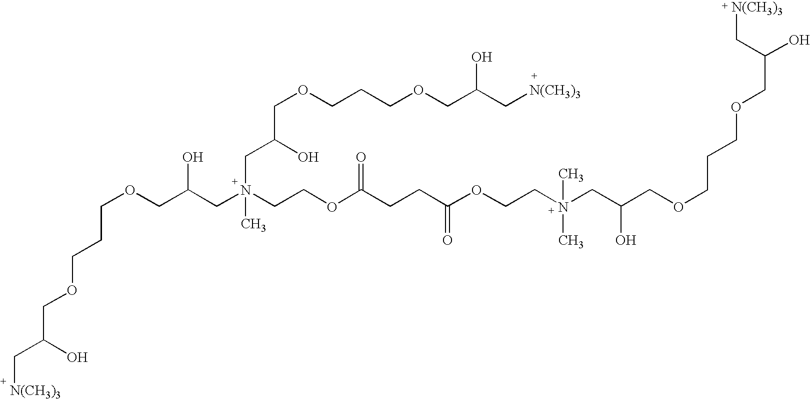

The following is a non-limiting example of a polyamine backbone which is fully quaternized.

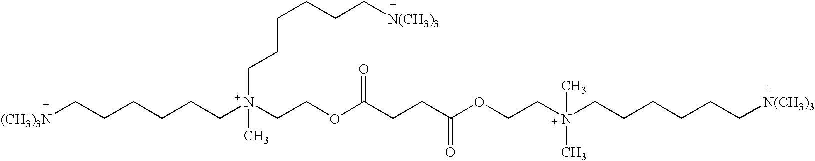

The following is a non-limiting example of a final zwitterionic polyamine according to the present invention.

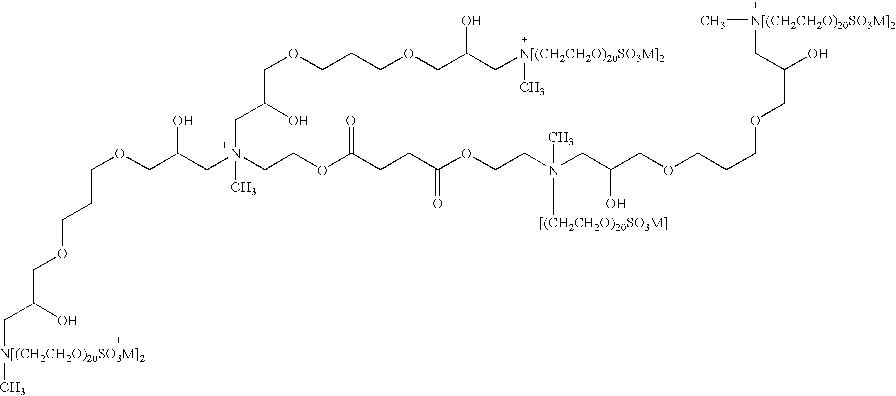

The following is a non-limiting example of a final zwitterionic polyamine according to the present invention.

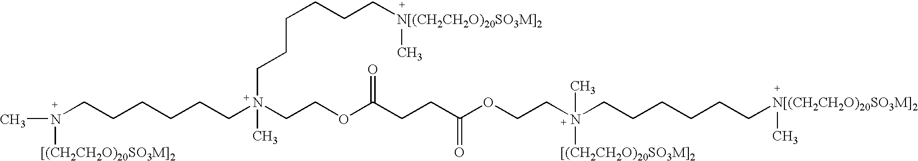

Preferred zwitterionic polymers of the present invention have the formula:

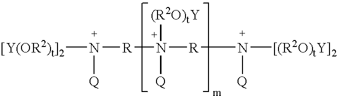

wherein R units have the formula —(R²O)_{w}R³— wherein R² and R³ are each independently selected from the group consisting of C₂-C₈ linear alkylene, C₃-C₈ branched alkylene, phenylene, substituted phenylene, and mixtures thereof. The R² units of the formula above, which comprise —(R²O)ₜY units, are each ethylene; Y is hydrogen, —SO₃M, and mixtures thereof, the index t is from 15 to 25; the index m is from 0 to 20, preferably from 0 to 10, more preferably from 0 to 4, yet more preferably from 0 to 3, most preferably from 0 to 2; the index w is from 1, preferably from about 2 to about 10, preferably to about 6.

Non-limiting examples of backbones according to the present invention include 1,9-diamino-3,7-dioxanonane; 1,10-diamino-3,8-dioxadecane; 1,12-diamino-3,10-dioxadodecane; 1,14-diamino-3,12-dioxatetradecane. However, backbones which comprise more than two nitrogens may comprise one or more repeating units having the formula:

H₂N—[R—NH]—

for example a unit having the formula:

H₂N—[CH₂CH₂OCH₂CH₂NH]—

is described herein as 1,5-diamino-3-oxapentane. A backbone which comprises two 1,5-diamino-3-oxapentane units has the formula:

H₂NCH₂CH₂OCH₂CH₂NHCH₂CH₂OCH₂CH₂NH₂.

Further suitable repeating units include 1,8-diamino-3,6-diaxaoctane; 1,11-diamino-3,6,9-trioxaundecane; 1,5-diamino-1,4-dimethyl-3-oxaheptane; 1,8-diamino-1,4,7-trimethyl-3,6-dioxaoctane; 1,9-diamino-5-oxanonane; 1,14-diamino-5,10-dioxatetradecane.

The zwitterionic polymers of the present invention preferably comprise polyamine backbone which are derivatives of two types of backbone units:
i) normal oligomers which comprise R units of type (i), which are preferably polyamines having the formula:

H₂N—(CH₂)ₓ]ₙ₊₁—[NH—(CH₂)ₓ]ₘ—[NB—(CH₂)ₓ]ₙ—NH₂
wherein B is a continuation of the polyamine chain by branching, n is preferably 0, m is from 0 to 3, x is 2 to 8, preferably from 3 to 6; and
ii) hydrophilic oligomers which comprise R units of type (ii), which are preferably polyamines having the formula:

H₂N—[(CH₂)ₓO]_{y}(CH₂)ₓ]—[NH—[(CH₂)ₓO]_{y}(CH₂)ₓ]ₘ—NH₂
wherein m is from 0 to 3; each x is independently from 2 to 8, preferably from 2 to 6; y is preferably from 1 to 8.

Depending upon the degree of hydrophilic character needed in the zwitterionic backbones, the formulator may assemble higher oligomers from these constituent parts by using R units of types (iii), (iv), and (v). Non-limiting examples include the epihalohydrin condensate having the formula:

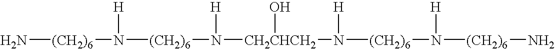

or the hybrid oligomer having the formula:

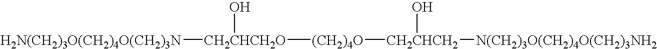

wherein each backbone comprises a mixture of R units.

As described herein before, the formulator may form zwitterionic polymers which have an excess of charge (Qᵣ less than 1 or greater than 1) or an equivalent amount of charge type (Qᵣ equal to 1). An example of a preferred zwitterionic polyamine according to the present invention which has an excess of anionic charged units, Qᵣ equal to 2, has the formula:

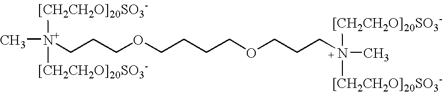

wherein R is a 1,3-propyleneoxy-1,4-butyleneoxy-1,3-propylene unit, w is 2; R¹ is —(R²O)ₜY, wherein R² is ethylene, each Y is —SO₃⁻, Q is methyl, m is 0, n is 0, t is 20. For zwitterionic polyamines of the present invention, it will be recognized by the formulator that not every R¹ unit will have a —SO₃⁻ moiety capping said R¹ unit. For the above example, the final zwitterionic polyamine mixture comprises at least about 90% Y units which are —SO₃⁻ units.

As described herein before, the formulator may form zwitterionic polymers which have an excess of charge or an equivalent amount of charge type. An example of a preferred zwitterionic polyamine according to the present invention which has an excess of backbone quaternized units, has the formula:

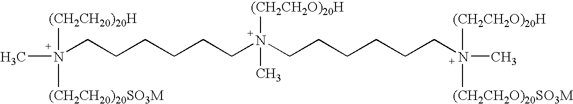

wherein R is a 1,5-hexamethylene, w is 2; R¹ is —(R²O)ₜY, wherein R² is ethylene, Y is hydrogen or —SO₃M, Q is methyl, m is 1, t is 20. For zwitterionic polyamines of the present invention, it will be recognized by the formulator that not every R¹ unit will have a —SO₃ moiety capping said R¹ unit. For the above example, the final zwitterionic polyamine mixture comprises at least about 40% Y units which are —SO₃⁻ units.

The liquid detergent compositions herein are in the form of an aqueous solution or uniform dispersion or suspension of surfactant, polymer, and optional other ingredients, some of which may normally be in solid form, that have been combined with the normally liquid components of the composition, such as the non-aminofunctional surfactant and any other normally liquid optional ingredients. Such a solution, dispersion or suspension will be acceptably phase stable and will typically have a viscosity which ranges from about 100 to 600 cps, more preferably from about 150 to 400 cps. For purposes of this invention, viscosity is measured with a Brookfield LVDV-II+ viscometer apparatus using a #21 spindle.

The liquid detergent compositions herein can be prepared by combining the components thereof in any convenient order and by mixing, e.g., agitating, the resulting component combination to form a phase stable liquid detergent composition. In a preferred process for preparing such compositions, a liquid matrix is formed containing at least a major proportion, and preferably substantially all, of the liquid components, e.g., nonionic surfactant, the non-surface active liquid carriers and other optional liquid components, with the liquid components being thoroughly admixed by imparting shear agitation to this liquid combination. For example, rapid stirring with a mechanical stirrer may usefully be employed. While shear agitation is maintained, substantially all of any anionic surfactants and the solid form ingredients can be added. Agitation of the mixture is continued, and if necessary, can be increased at this point to form a solution or a uniform dispersion of insoluble solid phase particulates within the liquid phase. After some or all of the solid-form materials have been added to this agitated mixture, particles of any enzyme material to be included, e.g., enzyme prills, are incorporated. As a variation of the composition preparation procedure hereinbefore described, one or more of the solid components may be added to the agitated mixture as a solution or slurry of particles premixed with a minor portion of one or more of the liquid components. After addition of all of the composition components, agitation of the mixture is continued for a period of time sufficient to form compositions having the requisite viscosity and phase stability characteristics. Frequently this will involve agitation for a period of from about 30 to 60 minutes.

The compositions of this invention, prepared as hereinbefore described, can be used to form aqueous washing solutions for use in the laundering of fabrics. Generally, an effective amount of such compositions is added to water, preferably in a conventional fabric laundering automatic washing machine, to form such aqueous laundering solutions. The aqueous washing solution so formed is then contacted, preferably under agitation, with the fabrics to be laundered therewith. An effective amount of the liquid detergent compositions herein added to water to form aqueous laundering solutions can comprise amounts sufficient to form from about 500 to 7,000 ppm of composition in aqueous washing solution. More preferably, from about 1,000 to 3,000 ppm of the detergent compositions herein will be provided in aqueous washing solution.

### EXAMPLES

The following examples illustrate the compositions of the present invention but are not necessarily meant to limit or otherwise define the scope of the invention herein.

### Example 1

The following liquid formulas are within the scope of the present invention.

| | 1a | 1b | 1c | 1d | 1e |
|---|---|---|---|---|---|
| Ingredient | wt % | wt % | wt % | wt % | wt % |
| sodium alkyl ether | 20.5% | 20.5 | 20.5 | | |
| sulfate | | | | | |
| branched alcohol sulfate | 5.8% | 5.8 | 5.8 | | |
| linear alkylbenzene | 2.5% | 2.5 | 2.5 | | |
| sulfonic acid | | | | | |
| alkyl ethoxylate | 0.8% | 0.8 | 0.8 | | |
| amine oxide | | | | | |
| citric acid | 3.5% | 3.5 | 3.5 | | |
| fatty acid | 2.0% | 2.0 | 2.0 | | |
| protease | 0.7% | 0.7 | 0.7 | | |
| amylase | 0.37% | 0.37 | 0.37 | | |
| lipase | | | | | |
| borax | 3.0% | 3.0 | 3.0 | | |
| calcium and sodium | 0.22% | 0.22 | 0.22 | | |
| formate formic acid | | | | | |
| amine ethoxylate | 1.2% | 1.2 | 1.2 | | |
| polymers | | | | | |
| zwitterionic amine | 1.6% | 1.6 | 1.6 | | |
| ethoxylate polymer | | | | | |
| sodium polyacrylate¹ | 0.6% | | | | |
| sodium polyacrylate | | 0.6 | | | |
| copolymer² | | | | | |
| sodium polyacrylate | | | 1.6 | | |
| copolymer³ | | | | | |
| DTPA⁴ | 0.25% | | | | |
| fluorescent whitening | 0.2% | | | | |
| agent | | | | | |
| ethanol | 2.9% | | | | |
| propanediol | 5.0% | | | | |
| diethylene glycol | 2.56% | | | | |
| polyethylene glycol 4000 | 0.11% | | | | |
| ethanolamine | 2.7% | | | | |
| sodium hydroxide | 3.67% | | | | |
| sodium cumene sulfonate | | | | | |
| silicone suds suppressor | 0.01% | | | | |
| perfume | 0.5% | | | | |
| Acid Blue 7⁵ | 0.01% | | | | |
| opacifier⁶ | | | | | |
| water | balance | balance | balance | balance | balance |
| | 100.0% | 100.0% | 100.0% | 100.0% | 100.0% |

¹Sodium salt of polyacrylic acid, Mn = 1000-4000 amu, PD < 5.
²Sodium salt of 90:10 polyacrylic acid-ethylene copolymer, Mn = 1000-4000 amu, PD < 5.
³Sodium salt of 90:10 polyacrylic acid-polyethyleneglycol acrylate copolymer, Mn = 1000-4000 amu, PD < 5.
⁴diethylenetriaminepentaacetic acid, sodium salt
⁵a non-tinting dye used to adjust formula color
⁶Acusol OP 301

All documents cited in the Detailed Description of the Invention are, are, in relevant part, incorporated herein by reference; the citation of any document is not to be construed as an admission that it is prior art with respect to the present invention.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A liquid detergent composition comprising a polymer comprising polyacrylic acid monomers having a number average molecular weight of from about 1000 to about 10,000 amu and a polydispersity of less than about 5 wherein the liquid detergent comprises less than about 50% of any non-aminofunctional solvent.

2. A liquid detergent composition according to claim 1 wherein the liquid detergent comprises less than about 40% of any non-aminofunctional solvent.

3. A liquid detergent composition according to claim 1 wherein the polymer is a homopolymer of polyacrylic acid monomer.

4. A liquid detergent composition according to claim 3 wherein the polyacrylic acid homopolymer has a number average molecular weight of from about 1000 to about 4000 amu.

5. A liquid detergent composition according to claim 4 wherein the polyacrylic acid homopolymer has a number average molecular weight of from about 1100 to about 3000 amu.

6. A liquid detergent composition according to claim 1 wherein the polymer is a copolymer comprising a mixture of acrylic acid monomers and hydrophilic monomers, the copolymer having a number average molecular weight of from about 1000 to about 4000 amu and a polydispersity of less than about 3.5.

7. A liquid detergent composition according to claim 6 wherein the copolymer comprises a mixture of acrylic acid monomers and hydrophilic monomers selected from the group consisting of polyethylene glycol acrylates, dicarboxylates, sulfonated monomers and mixtures thereof.

8. A liquid detergent composition according to claim 1 wherein the copolymer comprises a mixture of acrylic acid monomers and hydrophobic monomers, the copolymer having a number average molecular weight of from about 1000 to about 10,000 amu and a polydispersity of less than about 5.0.

9. A liquid detergent composition according to claim 8 wherein the copolymer comprises a mixture of acrylic acid monomers and hydrophobic monomers selected from the group consisting of alkyl, aryl, silicone, propoxy, butoxy monomers and mixtures thereof.

10. A liquid detergent composition comprising a polymer comprising polyacrylic acid monomers having a number average molecular weight of from about 1000 to about 10,000 amu and a polydispersity of less than about 5 and a water-soluble or dispersible, modified polyamine compound.

11. A liquid detergent composition according to claim 10 wherein the water-soluble or dispersible, modified polyamine compound comprises a polyamine backbone corresponding to the formula: 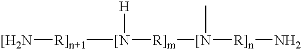
having a modified polyamine formula V₍ₙ₊₁₎WₘYₙZ,
or a polyamine backbone corresponding to the formula: 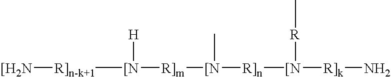
having a modified polyamine formula V₍ₙ₋ₖ₊₁₎WₘYₙY′ₖZ,
wherein k is less than or equal to n, said polyamine backbone prior to modification has a molecular weight greater than about 200 daltons, wherein
i) V units are terminal units having the formula: 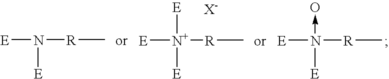
ii) W units are backbone units having the formula: 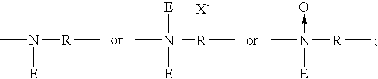
iii) Y units are branching units having the formula: 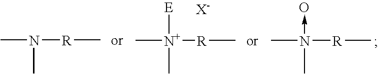
and
iv) Z units are terminal units having the formula: 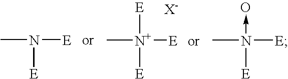
wherein backbone linking R units are selected from the group consisting of C₂-C₁₂ alkylene, —(R¹O)ₓR³(OR¹)ₓ—, —(CH₂CH(OR²)CH₂O)_{z}(R¹O)_{y}R¹(OCH₂CH(OR²)CH₂)_{w}—, —CH₂CH(OR²)CH₂— and mixtures thereof; provided that when R comprises C₁-C₁₂ alkylene R also comprises at least one —(R¹O)ₓR³(OR¹)ₓ—, —(CH₂CH(OR²)CH₂O)_{z}(R¹O)_{y}R¹—(OCH₂CH(OR²)CH₂)_{w}—, or —CH₂CH(OR²)CH₂-unit; R¹ is C₂-C₆ alkylene and mixtures thereof;
R² is hydrogen, —(R¹O)ₓB, and mixtures thereof;
R³ is C₁-C₁₂ alkylene, C₃-C₁₂ hydroxyalkylene, C₄-C₁₂ dihydroxy-alkylene, C₈-C₁₂ dialkylarylene, —C(O)—, —C(O)NHR⁵NHC(O)—, —C(O)(R⁴)ᵣC(O)—, —CH₂CH(OH)CH₂O—(R¹O)_{y}R¹OCH₂CH(OH)CH₂—, and mixtures thereof;
R⁴ is C₁-C₁₂ alkylene, C₄-C₁₂ alkenylene, C₈-C₁₂ arylalkylene, C₆-C₁₀ arylene, and mixtures thereof;
R⁵ is C₂-C₁₂ alkylene or C₆-C₁₂ arylene;
E units are selected from the group consisting of hydrogen, —(CH₂)ₚ—CO₂M, —(CH₂)_{q}SO₃M, —CH(CH₂CO₂M)CO₂M, —(CH₂)ₚPO₃M, —(R¹O)ₓB, and mixtures thereof; provided that when any E unit of a nitrogen is a hydrogen, said nitrogen is not also an N-oxide;
B is hydrogen, —(CH₂)_{q}SO₃M, —(CH₂)ₚCO₂M, —(CH₂)_{q}CH(SO₃M)-CH₂SO₃M, —(CH₂)_{q}CH(SO₂M)CH₂SO₃M, —(CH₂)ₚPO₃M, —PO₃M, and mixtures thereof;
M is hydrogen or a water soluble cation in sufficient amount to satisfy charge balance;
X is a water soluble anion;
k has the value from 0 to about 20;
m has the value from 4 to about 400;
n has the value from 0 to about 200;
p has the value from 1 to 6,
q has the value from 0 to 6;
r has the value 0 or 1;
w has the value 0 or 1;
x has the value from 1 to 100;
y has the value from 0 to 100; and
z has the value 0 or 1.

12. A liquid detergent composition according to claim 11 wherein the modified polyamine compound is selected from the group consisting of compounds having the formulas 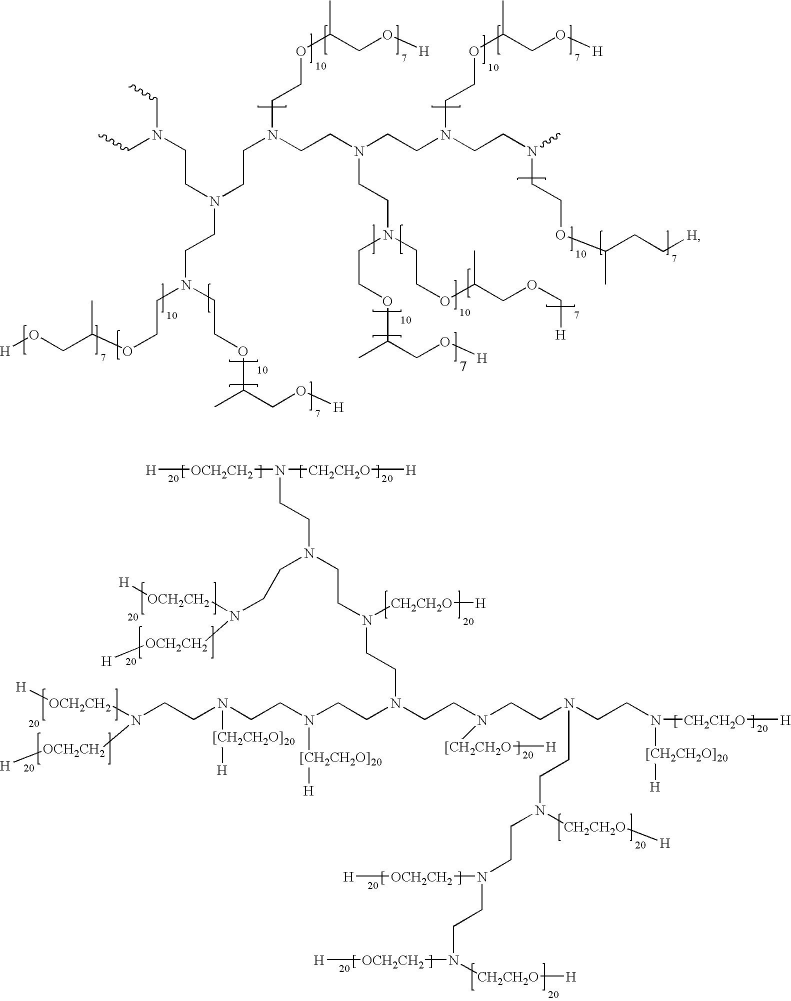
and mixtures thereof.

13. A liquid detergent composition comprising a polymer comprising polyacrylic acid monomers having a number average molecular weight of from about 1000 to about 10,000 amu and a polydispersity of less than about 5 and a zwitterionic polyamine.

14. A liquid detergent composition according to claim 13 wherein the zwitterionic polyamine has the formula:
[J-R]ₙ-J
wherein J is selected from the group consisting of:
i) primary amino units having the formula:
(R¹)₂N;
ii) secondary amino units having the formula:
—R¹N;
iii) tertiary amino units having the formula: 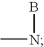
iv) primary quaternary amino units having the formula: 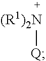
v) secondary quaternary amino units having the formula: 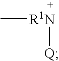
vi) tertiary quaternary amino units having the formula: 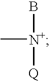
vii) primary N-oxide amino units having the formula: 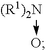
viii) secondary N-oxide amino units having the formula: 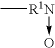
ix) tertiary N-oxide amino units having the formula: 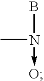
x) and mixtures thereof;
wherein B is a continuation of the backbone by branching having the formula:
[J-R]—;
R is a hydrophilic backbone unit selected from the group consisting of:
i) C₂-C₁₂ linear alkylene, C₃-C₁₂ branched alkylene, or mixtures thereof;
ii) alkyleneoxyalkylene units having the formula:
—(R²O)_{w}(R³)—
iii) hydroxyalkylene units having the formula: 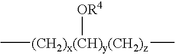
iv) hydroxyalkylene/oxyalkylene units having the formula: 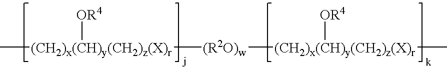
v) carboxyalkyleneoxy units having the formula: 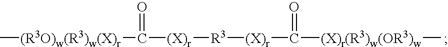
vi) and mixtures thereof;
R¹ is selected from the group consisting of:
i) hydrogen;
ii) C₁-C₂₂ alkyl;
iii) C₇-C₂₂ arylalkyl;
iv) —[CH₂CH(OR⁴)CH₂O]ₛ(R²O)ₜY;
v) anionic units;
vi) and mixtures thereof;
R² is selected from the group consisting of ethylene, 1,2-propylene, 1,3-propylene, 1,2-butylene, 1,4-butylene, and mixtures thereof;
R³ is C₂-C₈ linear alkylene, C₃-C₈ branched alkylene, phenylene, substituted phenylene, and mixtures thereof;
R⁴ is hydrogen, C₁-C₄ alkyl, —(R²O)ₜY, and mixtures thereof;
Q is a quaternizing unit selected from the group consisting of C₁-C₄ linear alkyl, C₁-C₄ hydroxyalkyl, benzyl, (R²O)ₜY, and mixtures thereof;
X is oxygen, —NR⁴—, and mixtures thereof;
Y is hydrogen, C₁-C₄ linear alkyl, an anionic unit, and mixtures thereof;
the index j is from 0 to 20; the index k is from 1 to 20; n is from 1 to 99; the index r is 0 or 1; the index s is from 0 to 5; the index t has an average value of from about 0.5 to about 100; the index w is from 0 to 25; the indices x, y, and z are each independently from 0 to 6.

15. A liquid detergent composition according to claim 14 wherein the zwitterionic polyamine has the formula: 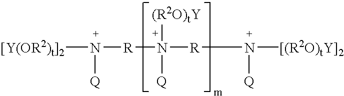
wherein R units have the formula —(R²O)_{w}R³— wherein R² and R³ are each independently selected from the group consisting of C₂-C₈ linear alkylene, C₃-C₈ branched alkylene, phenylene, substituted phenylene, and mixtures thereof; Y is an anionic unit selected from the group consisting of —(CH₂)_{f}CO₂M, —C(O)(CH₂)_{f}CO₂M, —(CH₂)_{f}PO₃M, —(CH₂)_{f}OPO₃M, —(CH₂)_{f}SO₃M, —CH₂(CHSO₃M)(CH₂)_{f}SO₃M, —CH₂(CHSO₂M)(CH₂)_{f}SO₃M, and mixtures thereof; M is hydrogen, a water soluble cation, and mixtures thereof; the index f is from 0 to about 10; Q is a quaternizing unit selected from the group consisting of C₁-C₄ linear alkyl, C₁-C₄ hydroxyalkyl, benzyl, (R²O)ₜY, and mixtures thereof; the index m is from 0 to 20; the index t is from 15 to 25.

16. A liquid detergent composition according to claim 14 further comprising a water-soluble or dispersible, modified polyamine compound.
